(19) United States
(12) Patent Application Publication
(10) Pub. No.: US 2013/0196734 A1
(43) Pub. Date: Aug. 1, 2013

(54) Systems and Methods for Providing Lottery Game Play Through an Unmanned Terminal

(71) Applicant: LINQ3 TECHNOLOGIES LLC, New York, NY (US)

(72) Inventor: Daniel Cage, Los Angeles, CA (US)

(73) Assignee: LINQ3 TECHNOLOGIES LLC, New York, NY (US)

(21) Appl. No.: 13/829,776

(22) Filed: Mar. 14, 2013

Related U.S. Application Data
(63) Continuation of application No. 11/734,207, filed on Apr. 11, 2007.
(60) Provisional application No. 60/886,818, filed on Jan. 26, 2007.

(51) Int. Cl. G07F 17/32

(52) U.S. Cl. CPC G07F 17/329
USPC 463/17

(57) ABSTRACT

A game play system comprises a banking system that includes at least one terminal configured for financial transactions and an acquirer transaction server coupled with the terminal, the acquirer transaction server configured to provide game plays to a user through the terminal. The game play system further comprises a game play authority in communication with the acquirer transaction server, the game play authority configured to receive game play requests from the acquirer transaction server and game play information from one or more authorities associated with various game plays.

### RELATED APPLICATION INFORMATION

This application claims priority under 35 U.S.C. 199(e) to U.S. Provisional Patent Application 60/886,818, entitled “Systems and Methods for Integrating ATM and Lottery Functions,” filed Jan. 26, 2007, which is incorporated herein by reference in its entirety.

### BACKGROUND INFORMATION

1. Field

The embodiments described below are directed to electronic lottery game play, and more particularly to providing lottery game play through existing ATM infrastructures.

2. Background

Use of ATM, debit, banking, credit, etc., cards is ubiquitous. In fact, the distinction between such cards is diminishing as many conventional cards can act as more than one type of card. Further, more and more features and capabilities are being added to conventional cards. For example, conventional cards will soon be equipped with contact-less smart card technology, allowing the user to simply wave their card in front of an appropriate terminal in order to complete a transaction. Additionally, more and more cards will include microprocessors, or the like and the ability to store more data related to the user and the user's accounts, even allowing the card to be used for multiple accounts.

To date, conventional cards typically do not provide non-financial transaction capabilities. In other words, while conventional cards are making it easier to perform financial transactions, they do not provide the ability to access other systems such a lottery systems, or other game systems. This is because the typically financial infrastructures, e.g., ATM infrastructures, are not interfaced with other infrastructures such as lottery infrastructures.

### SUMMARY

A method for providing games through terminal configured for financial transactions comprises, in response to the initiation of a financial transaction via the terminal, determining whether game plays are available and when it is determined that game plays are available, then determining what game type of game plays are available. Once the type of game plays is determined, presenting game play options via the terminal, then in response to a game play selection of one of the options, authenticating a user and obtaining the game play information from a an authority associated with the game play selection. The method further comprises presenting the game play information to the authenticated user via the terminal.

In another aspect, a game play system comprises a banking system that includes at least one terminal configured for financial transactions and an acquirer transaction server coupled with the terminal, the acquirer transaction server configured to provide game plays to a user through the terminal. The game play system further comprises a game play authority in communication with the acquirer transaction server, the game play authority configured to receive game play requests from the acquirer transaction server and game play information from one or more authorities associated with various game plays.

These and other features, aspects, and embodiments of the invention are described below in the section entitled “Detailed Description.”

### BRIEF DESCRIPTION OF THE DRAWINGS

Features, aspects, and embodiments of the inventions are described in conjunction with the attached drawings, in which:

FIG. 1 is a diagram illustrating an example integrated lottery and ATM system in accordance with one embodiment;

FIG. 2 is a diagram illustrating an example method for accessing a game play through a ATM network in accordance with one embodiment;

FIG. 3 is a flow chart illustrating an example method for determining a user's eligibility to play a lottery game in the system of FIG. 1 in accordance with on embodiment;

FIG. 4 is a diagram illustrating an example method for processing a transaction request within the system of FIG. 1 in accordance with one embodiment;

FIG. 5 is a diagram illustrating an example method for authenticating the user in the system of FIG. 1 in accordance with on embodiment; and

FIG. 6 is a diagram illustrating a process overview for the system of FIG. 1 in accordance with one embodiment.

### DETAILED DESCRIPTION

The systems and methods described below are directed to providing integrated ATM access and lottery game play. It will be understood, however, that the systems and methods described below are not necessarily limited to ATM and lottery transactions. For example, other types of terminals and transactions can be provided as well as other types of game plays. Other types of terminals that can be provided include Point-Of-Sale (POS) terminal including, e.g., grocery store POS terminals, gas pump POS terminals, etc. Generally, any type of terminal configured for POS transactions, e.g., magnetic stripe “swipe” terminals, contact or contact-less smart card terminals, etc. (collectively unmanned terminals), can be provided in accordance with the systems and methods described herein. Accordingly, the embodiments described below will be seen as representative examples and not necessarily as limiting the embodiments to particular infrastructures, systems, transactions, or game plays.

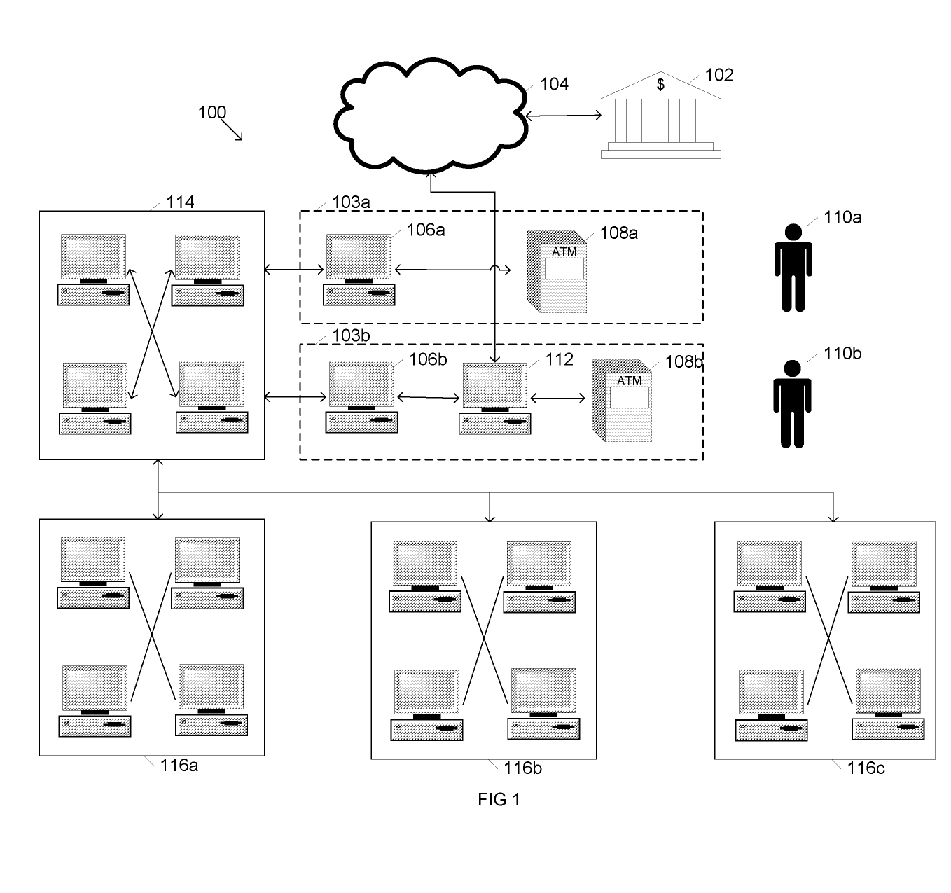

FIG. 1 is a diagram illustrating an example integrated ATM and lottery game play system 100 configured in accordance with one embodiment. As can be seen, a plurality of banking systems, e.g., banking systems 103a and 103b can be interfaced with a game play authority 114. The term “authority” as used herein is intended to refer to all of the systems, hardware and software, required to perform the functions described below. Thus, the term authority is used to refer to all of the servers, routers, terminals, computers, processors, databases, application interfaces, applications, etc., required to perform the functions described below.

Each banking system incorporates an acquirer transaction server, for example acquirer transaction servers 106a and 106b. Acquirer transaction servers 106a and 106b are configured to provide an interface between game play authority 114 and the more traditional banking infrastructures comprising banking systems 103a and 103b. In certain instances, an acquirer transaction server will be interfaced directly to stand-alone ATMs comprising part of the banking system. For example, in system 103a acquirer transaction server 106a is interfaced directly with a stand-alone ATM 108a. It will be understood that system 103a can comprise a plurality of stand-alone ATMs 108a, all interfaced with acquirer transaction server 106a, and that a single stand-alone ATM 108a is illustrated for simplicity. In other systems, e.g., system 103b, acquirer transaction server 106b will be interfaced with a host processor 112. Host processor 112 is then interfaced with one or more ATMs, such as ATM 108b. Again, it will be understood that host processor 112 can be interfaced with a plurality of ATMs and that a single ATM 108b is shown for simplicity.

In systems such as system 103b, host processor 112 provides much of the processing resources required for transactions using ATM 108b. In systems such as 103a, such processing resources are distributed among stand-alone ATMs, such as stand-alone ATM 108a.

Banking Systems 103a and 103b are interfaced with one or more issuing bank authorities 102 via network 104. Issuing bank authority 102 is associated with the user accounts of users 110a and 110b. Thus, users 110a and 110b must be authenticated by issuing bank authorities 102 prior to transaction completion. Once the transaction is completed, the transaction information is forwarded from banking systems 103a and 103b to the appropriate issuing bank authority 102 for transaction completion. The components comprising a typical issuing bank authority 102 are well known and will not be discussed in detail here.

Network 104 can comprise one or more wired or wireless Wide Area Networks (WANs), one more wired or wireless Metropolitan Area Networks (MANs), one or more wired or wireless Local Area Networks (LANs), and/or one or more wired or wireless Personal Area Networks (PANs). Communication can occur over network 104 using any one of a variety of communication protocols suited for such a network(s).

The components of systems 103a and 103b must communicate via networking interfaces as well. In some instances, components comprising systems 103a and 103b can be co-located, while in other instances, the components will be geographically distributed. For example, acquirer transaction server 106b may be co-located with host processor 112, while ATM 108b is located at a geographically remote location. Similarly, stand-alone ATM 108a can be located at a location that is geographically remote from acquiring transaction server 106a. Accordingly, the components comprising systems 103a and 103b can communicate via one or more wired or wireless WANs, one or more wired or wireless LANs, one or more wired or wireless MANs and/or one or more wired or wireless PANs, and using one or more communication protocols as required by a particular implementation.

In general, the components comprising systems 103a and 103b will communicate over the banking systems intranet. It will be understood that communications within an intranet are generally more secure than communications external to the intranet, and that communications outside of the intranet are generally limited in order to increase security. In system 100, game play authority 114 is located outside of the banking systems' intranets. Accordingly, acquiring transaction servers 106a and 106b can be configured to communicate with game play authority 114 via secure connections 113a and 113b.

Secure connection methods are well known and will not be described in detail here for the sake of brevity; however, it will be understood that game play authority 114 can be interfaced with banking systems 103a and 103b via one or more wired or wireless WANs, one or more wired or wireless MANs, one or more wired or wireless LANs, and/or one or more wired or wireless PANs, and using one or more communication protocols as required by a particular implementation.

Game play authority 114 is interfaced with various lottery authorities 116a, 116b, and 116c. The lottery authorities 116 are configured to provide lottery game play ability for plurality of lottery games, e.g., different state lottery games. In certain embodiments, one or more lottery authorities 116a, 116b and 166c can be configured to provide game play capability for games other than lottery games. Game play authorities 116a, 116b and 116c can be interfaced with a game play authority 114 via one or more wired or wireless WANs, one or more wired or wireless MANs; one or more wired or wireless LANs and/or one or more wired or wireless PANs, and using one or more communication protocols as required by a particular implementation. It will also be understood that three lottery authorities 116a, 116b, and 116c, are provided by way of example only and that system 100 is not limited to certain number of lottery authorities.

In system 100, the existing banking system and issuing bank information can be leveraged in order to provide authentication, play limiting, re-marketing, and automatic redemption for lottery games provided via game play authority 114. For example, a high degree of user authentication can be achieved because all users can be verified via a physical media, i.e., their bank or ATM card, a logical code, i.e., their Personal Identification Number (PIN), as well as via the associated issuing bank before the transaction is completed. This is commonly referred to as multi-factor authentication, i.e., the user is authenticated via something they have (their ATM card) and something they know (their PIN).

Using the authentication factors described above, e.g., the user's current location, home location, and age eligibility can be easily confirmed before allowing the user to participate in the game, or games being offered by game play authority 114. Further, the possession of the ATM card and the proper PIN, ensures that the user is an authorized user for the funds being offered for participation in the game. This can be referred to as account access authentication, and use of the factors described above ensures that there will be little or no fraud as a result of the strong third party verification provided. Additionally, age eligibility and game eligibility can be authenticated. In general, the mere possession of an ATM or bank card by an authorized user ensures that the user is at least 18 years of age. This is due to the issuing regulations of issuing banks. For many game types made available via game play authority 114, the eligibility age is also 18 years of age. Accordingly, simply verifying the possession of the ATM or bank card can often also verify the age eligibility of the user.

Certain games may only be available to certain users. For example, a user's residence and/or location may dictate whether the user is eligible to play certain games, such as certain state lotteries. Further, only certain games may be made available via certain banking systems. In this respect, acquiring transaction servers 106a and 106b can determine the location of the user by verifying the location of the ATM 108a or 108b they are using. The location information would be verified by querying the banking system's infrastructure. This information can be used to properly determine which game types can be made available to the user. Additionally, the user's residence location can in some instances be ascertained from the associated issuing bank authority 102. This information can also be used to verify the user's game eligibility, e.g., eligibility for a certain states lottery.

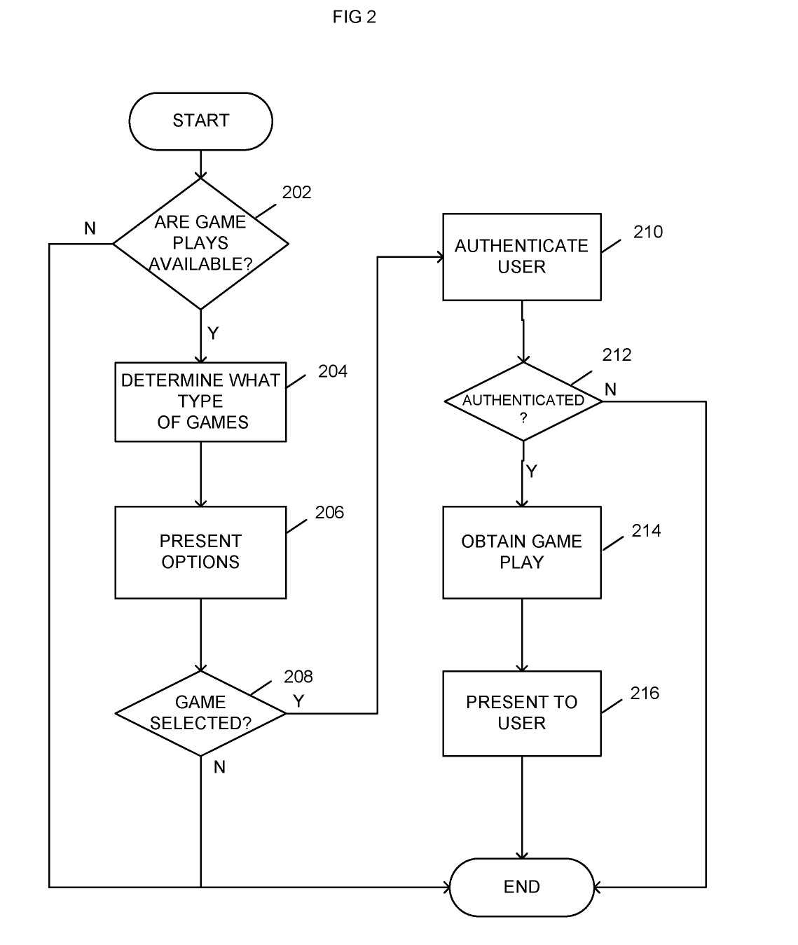

FIG. 2 is a flow chart illustrating an example process by which a user can access a game via an ATM terminal in accordance with one embodiment of the systems and methods described herein. First, in step 202, once a user has initiated a transaction via an ATM machine, the system can determine whether game plays are available for that user. Whether game plays are available can, depending on the embodiment, be determined based on the user's age, account status, residence, location, banking institution, etc. If no game are available, then the process ends; however, the user can continue with any conventional ATM transaction the user may have initiated.

If game plays are available, then precisely what type of games can be determined in step 204. In step 206, the game options can be presented to the user via the ATM machine's user interface, i.e., the game options can be displayed on the ATM display. If the user does not select any of the game options, then the process can end, although the user can continue with any conventional ATM transaction the user may have initiated.

If the user does select a game, then the user can be authenticated in step 210. If the authentication fails then the process can end, although the user can continue with any conventional ATM transaction the user may have initiated, unless prohibited due to the failed authentication But if authentication is successful, then the selected game play can be obtained from the appropriate lottery authority in step 214 and the game play can be presented to the user, e.g., the lottery numbers can be printed out for the user via the ATM machine. The process will then end, although the user can continue with any conventional ATM transaction the user may have initiated. Additionally, in certain embodiments, the user can be allowed to go back and select a second game (step 208).

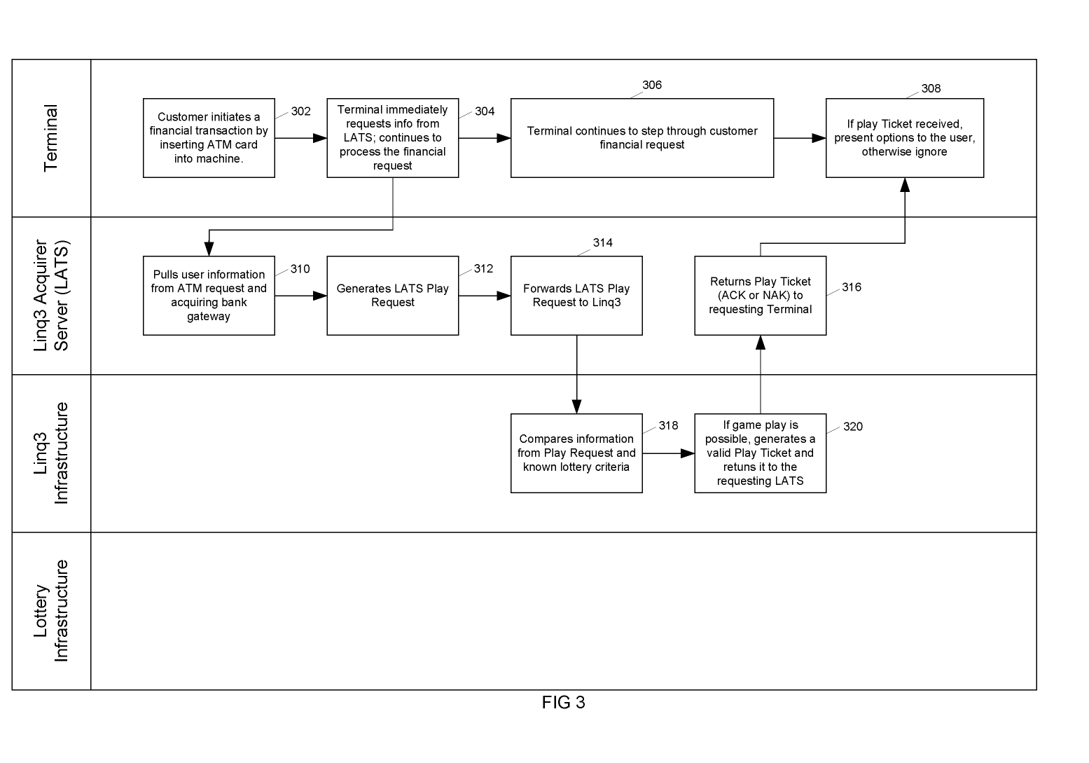

FIGS. 3 through 6 are flowcharts illustrating the various processes carried out by System 100, in order to implement the process of FIG. 2 as seen in detail from the perspective of the various components comprising System 100. For example, FIG. 3 is a diagram illustrating an example process for determining a customer's eligibility for game play in accordance with one embodiment. First, in step 302, the terminal, e.g., ATM machine 108a or 108b, receives a transaction initiation request initiated by a user, e.g., user 110a or 110b. As will be understood, the transaction is usually initiated via the user inserting their ATM card, or other type of card, into ATM machine 108a or 108b. In step 304, the terminal will then request information from the associated acquiring transaction server in step 304. In step 306, the terminal will continue to step through any financial transactions initiated by the user. In step 308, if a game play, or play ticket is received from the associated acquiring transaction server, then a terminal will present the game play options to the user in step 308.

In step 310, the acquirer transaction server will begin accessing user information in response to the request of step 304. As explained above, this information can include the authentication information obtained by the associated issuing bank authority. In step 312, the acquirer transaction server will then generate a play request, which is forwarded to the associated game play authority in step 314. In one embodiment, the game play request can comprise the customer's name, account number, card type, terminal location, or some combination thereof. This information can generally be obtained from the associated issuing bank authority 102.

In step 316, the acquirer transaction server can forward an eligible play ticket received from the game play authority to the terminal. An eligible play ticket is generated by the game play authority after the game play authority compares the information obtained in the game play request with the lottery, or game play criteria associated with the respective lottery authority 116. If the game play authority determines that game play is possible based on the comparison of step 318, then the game play authority can generate a valid game play ticket in step 320 and return it to the appropriate acquirer transaction server.

The eligible game play ticket can be completed based on further information received from the terminal in response to the options presented in step 308. In such instances, the eligible game play ticket will then be resubmitted to the game play authority for final processing and purchase. In other embodiments, the game play authority can be configured to query for previously stored customer options, e.g., stored numbers or previous customer plays. This information can then be encapsulated into the eligible play ticket returned in step 320.

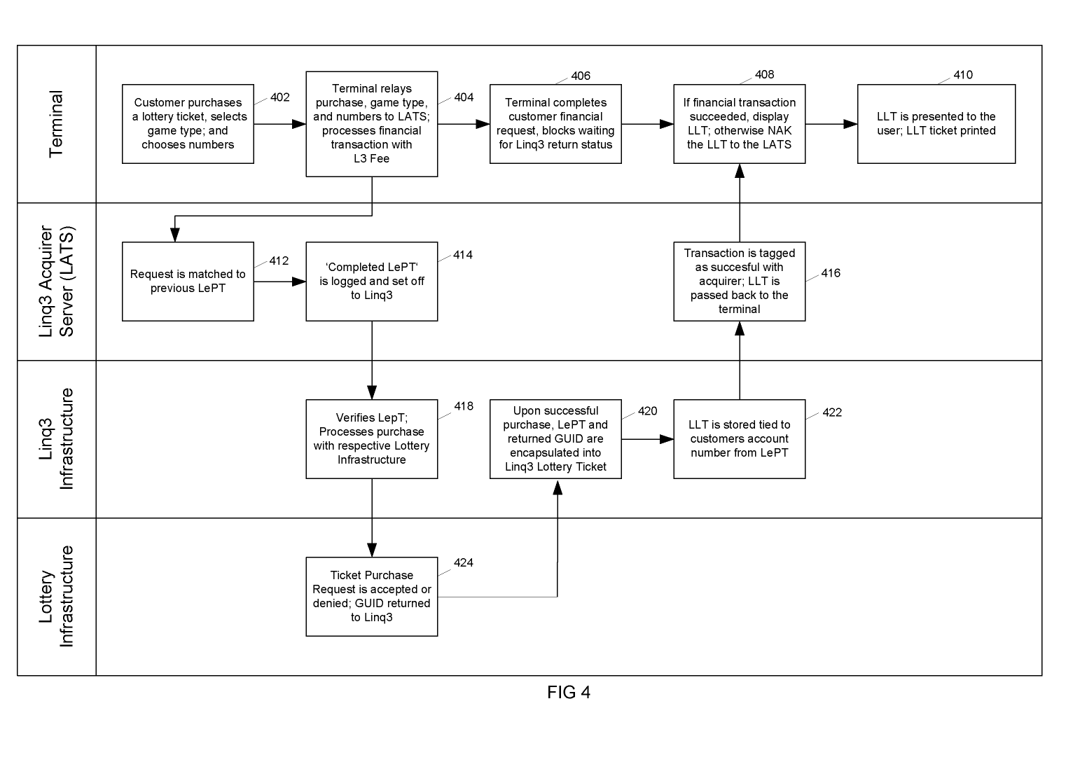

FIG. 4 is a diagram illustrating an example process for processing a transaction request via a terminal, such as terminal 108a or 108b, in accordance with one embodiment. With reference to FIG. 3, game play options can be presented to the user via the terminal in step 308. In step 402, the user can select to purchase a game play, or lottery ticket and select the game type. The user can then input their game play information, e.g., lottery numbers, via the terminal. In step 404, the terminal will relay this information, i.e., the game play purchase, game type, and game information, to the associated acquirer transaction server and will process the fee associated with the game play. For example, this fee can just be added into, or process with any financial transactions engaged in by the user via the terminal. In step 406, the terminal can continue to process any such financial requests.

In step 408, if the financial transaction succeeds, including processing of the game play fee, then the terminal can be configured to display a lottery, or game play ticket to the user via the terminal. If the financial transaction did not succeed, then the terminal can forward a failure notice to the associated acquirer transaction server in step 408. Otherwise, the terminal can print the lottery ticket in step 410. The ticket can comprise game play information, such as the numbers played by the user, e.g., batch numbers, as well as verification numbers from the lottery authority.

In step 412, the associated acquirer transaction server can receive the game play request from the terminal and match the request to a previous eligible play ticket, i.e., generated by the game play authority in step 320 and provided to the acquirer transaction server in step 316. In step 414, the eligible play ticket can be completed using the information received in step 412 and forwarded to the game play authority. In certain embodiments, the completed eligible play ticket can also be logged by the acquirer transaction server in step 414. In step 416, a lottery ticket can be passed back to the terminal for display in step 408.

In step 418, game play authority 114 can receive the completed eligible play ticket and process the game play purchased by forwarding the information to the respective lottery authority. Upon successful completion of the purchase, the eligible play ticket can be returned to the game play authority in step 420 and a lottery ticket can be generated. In step 422, the lottery ticket can be stored and associated with the user's account based on the information contained in the eligible play ticket. The lottery ticket can then be forwarded to the game play authority. In step 424, the appropriate lottery authority can receive the eligible play ticket information from the game play authority and then accept or deny the request. Assuming the request is accepted, then the information needed to finish the lottery ticket in step 420 can be forwarded to the game play authority.

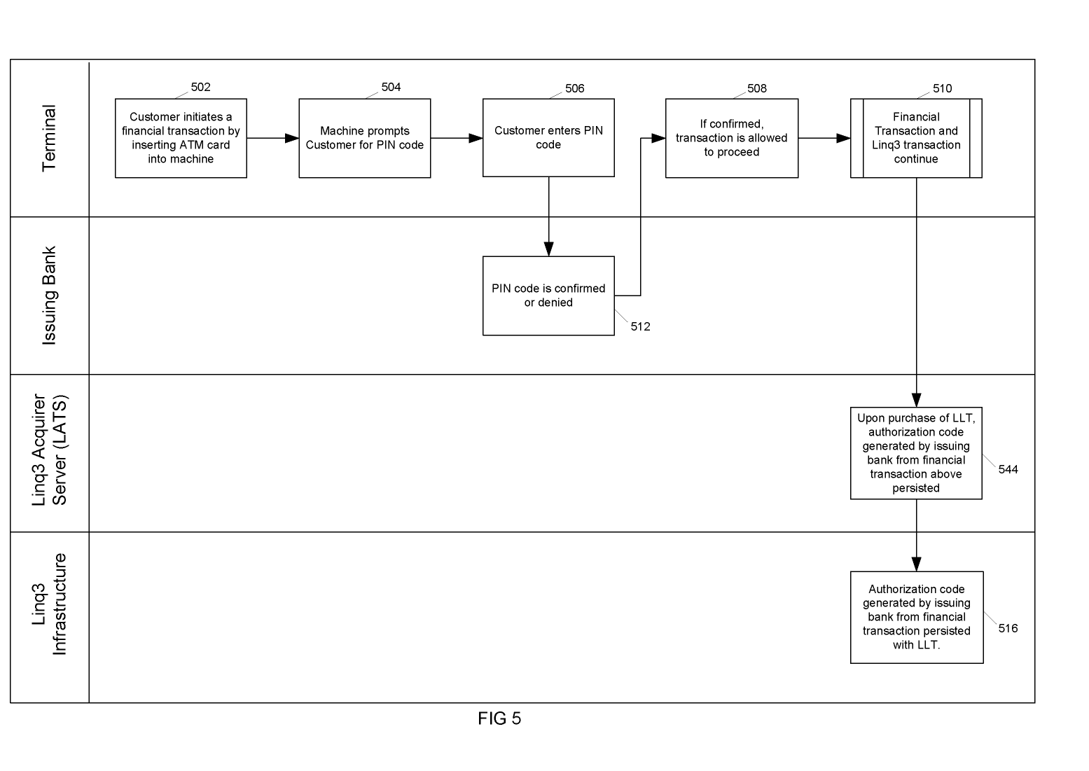

FIG. 5 is a diagram illustrating an example process for customer authentication in accordance with one embodiment. In step 502, the customer can initiate a financial transaction, e.g., by inserting their ATM card into a terminal. In step 504, the terminal can prompt the customer to enter their PIN and in step 506, the PIN can be received as entered by the customer. In step 508, if the PIN is confirmed then the transaction is allowed to proceed, and in step 510 the financial transaction and any game play transactions can continue. In step 512, the issuing bank authority can receive the PIN from the terminal for verification. The issuing bank authority, can then provide the confirmation to the terminal in step 508. In step 514, the associated acquirer transaction server can use the authorization code generated by the issuing bank authority for the financial transaction upon purchase of a game play, or lottery ticket. In step 516, the authorization code can be forwarded to game play authority 114 to authenticate the user.

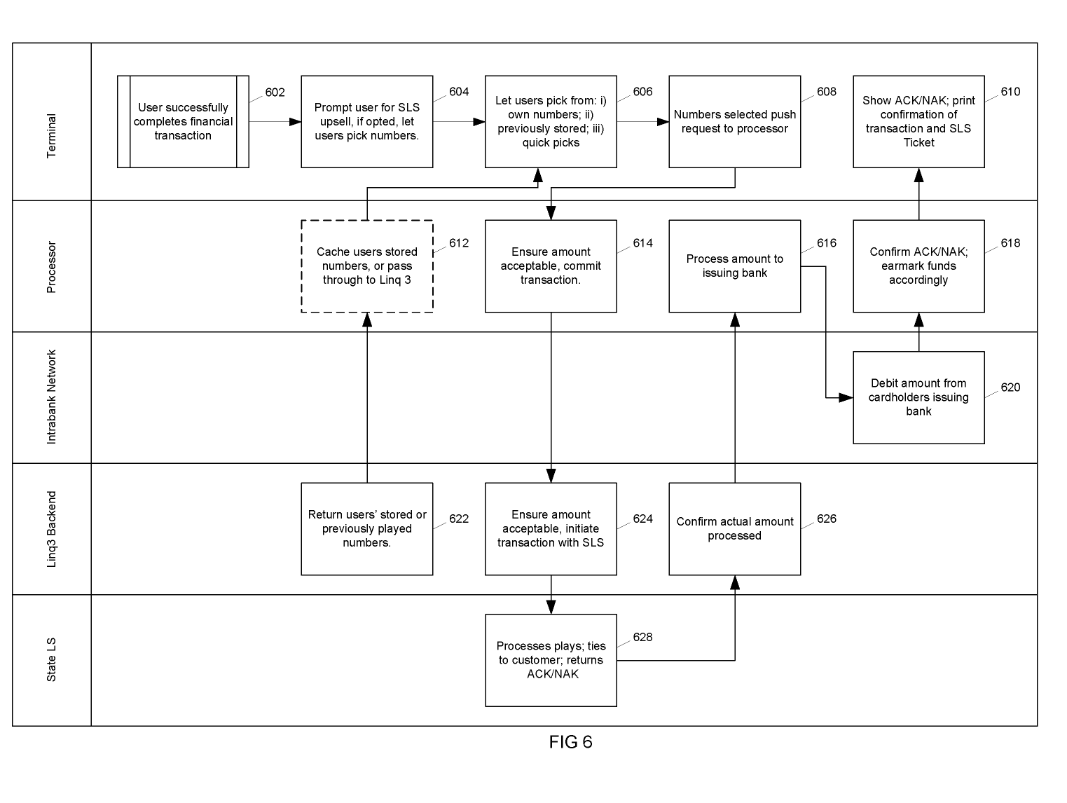

FIG. 6 is a flowchart illustrating an example overall process flow for a game play transaction using system 100. The process illustrated in FIG. 6 can be referred to as an up-sell process where upon completion of a financial transaction the user is provided the option to play one or more games via the terminal. First, in step 602, a user can successfully complete a financial transaction via a terminal, such as terminal 108a or 108b. In step 604, the terminal can be configured to automatically prompt the user to play one of the games available via the terminal. If the user elects to play a game, then in step 606, the terminal can be configured to allow the user to play the game, e.g., by supplying numbers for the game play. In certain embodiments, the user can be allowed to select their own numbers, previously stored numbers, or quick pick numbers.

Once the numbers are selected, then in step 608, the numbers are provided to the acquiring bank's processor, e.g., processor 112, or in system such as system 103a, the processing function can be implemented within terminal 108a. In step 610, the terminal can be configured to display an acknowledgement or a non-acknowledgement to the user and print the confirmation of the transaction success or failure.

If stored numbers are to be used, then in step 612, the processor can receive the user stored numbers from a memory, e.g., a cash memory, or from the associated acquirer transaction server. These numbers can then be displayed to the user for election in step 606. In step 614, the processor can be configured to ensure that the game play fee is available before committing to the transaction. In step 616, the fee can be processed by the processor and forwarded to the associated issuing bank authority. Assuming the funds for the game play fee are available, then the processor will receive an acknowledgement in step 618 and earmark the funds accordingly. The acknowledgement will then be forwarded to the terminal for confirmation in step 610. If the funds are not available, then the processor will receive a non-acknowledgement in step 618 which can be forwarded for confirmation in step 610.

In step 620, the interbank network, e.g., network 104 and issuing bank authority 102, can receive the game play fee in order to confirm that funds are available in the user's account and to debit the user's account the appropriate funds. Assuming the funds are available, then the interbank network will forward an acknowledgement; however, if the funds are not available then the interbank network will forward a non-acknowledgement.

In step 622, the game play back end, e.g., the acquiring transaction server and game play authority, can be configured to access a user stored or previously played numbers and forward them via the bank processor to the terminal for display to the user. In step 624, the game play back end can be configured to ensure that the game play fee is acceptable before initiating the transaction with the appropriate lottery authority.

In step 626, the game play back end can receive an acknowledgement or non-acknowledgement from the associated lottery authority, which it can forward to the processor for forwarding to the associated issuing bank authority. In step 628, the appropriate lottery authority can process the game play request, tie the game play request to the customer, e.g., via the customer's account, and return the acknowledgement or non-acknowledgement.

Thus, the existing banking terminals, networks, authentication procedures, etc., can be linked with lottery authorities in order to provide easy access and payment for lottery games. Further, the banking network processes can be used for game play eligibility verification, game play limiting, payment, and authentication, which can reduce costs and increase game plays. Still further, one of skill in the art will realize that the game play backend, i.e., acquirer transaction server and game play authority, are implemented in a non-parasitic manner. In other words, while the game play backend uses the existing banking system for access to users and authentication, it also provides a separate game play operation and provides the associate benefits. Further, the existing hardware and infrastructure do not need to be altered in order to add the game play capability

In other embodiments, since a relationship with the user is maintained, various degrees of remarketing and continued marketing can be employed. For example, users can be offered points via a loyalty/affinity program or the opportunity to play their favorite game types and numbers via a ‘quick select’ play on the POS.

In certain embodiments, automatic redemption of winning tickets to the user's bank account can be provided as a free service, or for a fee. This will provide the user with the confidence that when they purchase a winning ticket through the system of FIG. 1, then they are assured to reap the benefit of their purchase, regardless of who holds the paper stock.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

1-30. (canceled)

31. A system for facilitating a lottery purchase transaction at an automated teller machine (ATM) terminal, comprising:
a game play authority system located outside of a banking system intranet and adapted for communication with one or more acquirer transaction server using a least one communication protocol,
wherein the one or more acquirer transaction server is adapted to directly communicate with at least one ATM terminal over the banking system intranet;
wherein the one or more acquirer transaction server is adapted to directly communicate with a processor associated with the ATM terminal over an interbank network;
wherein the one or more acquirer transaction server further comprises one or more memory devices, the one or more acquirer transaction servers operable to perform the process comprising actions a) through e) encoded in said one or more memory devices:
a) receiving a lottery purchase request from a user at the ATM terminal;
b) forwarding the lottery purchase request to the game play authority system;
c) receiving lottery purchase information from the game play authority and forwarding the lottery purchase information to the user at the ATM terminal;
d) receiving authentication information corresponding to the user from the processor;
e) forwarding the authentication information corresponding to the user to the game play authority system over the interbank network;
wherein the game play authority system further comprises one or more memory devices encoded with instructions for performing the process comprising actions f) through l):
f) receiving the lottery purchase request and the authentication information from the at least one acquirer transaction server;
g) generating a game play request, wherein the game play request corresponds to the received lottery purchase request and authentication information;
h) generating game play acceptance information;
i) generating lottery purchase information based upon the game play acceptance information and the lottery purchase request;
j) associating the lottery purchase information with the lottery purchase request;
k) storing the lottery purchase information; and
l) sending the lottery purchase information to the one or more acquirer transaction server for transmission to the user at the ATM terminal.

32. The system of claim 31, wherein the game play authority system comprises one or more game play authority servers, and wherein receiving the lottery purchase request comprises receiving the lottery purchase request at the one or more game play authority servers.

33. The system of claim 31, wherein the game play authority system comprises one or more game play authority servers and one or more lottery authority servers, further comprising communicating the game play request from one or more of the game play authority servers to the one or more lottery authority servers.

34. The system of claim 31, wherein the game play authority system comprises one or more lottery authority servers, and wherein generating game play acceptance information comprises generating game play acceptance information at the one or more lottery authority servers.

35. The system of claim 34, wherein the game play authority system further comprises one or more game play authority servers, and further comprising communicating game play acceptance information from the one or more lottery authority servers to the one or more game play authority servers.

36. The system of claim 31, wherein the game play authority system comprises one or more game play authority servers, and wherein storing the lottery purchase information further comprises storing the lottery purchase information at the one or more game play authority servers.

37. The system of claim 31, wherein the game play authority system comprises one or more game play authority server and one or more lottery authority server communicating via one of:
one or more wired or wireless WAN;
one or more wired or wireless MAN;
one or more wired or wireless LAN; and
one or more wired or wireless PAN.

38. The system of claim 31, wherein the banking system intranet is an ATM network.

39. The system of claim 31, wherein the banking system intranet is a host processor network.

40. The system of claim 31, wherein the game play authority system comprises one or more game play authority server and a plurality of lottery authority servers, and wherein the game play authority server is adapted for communication with the plurality of lottery authority servers.

41. The system of claim 40, wherein the one or more memory device of the game play authority system is further encoded with instructions for performing the process comprising actions m) through n):
m) identifying a location of the ATM terminal from which the lottery purchase request was originated; and
n) selecting a lottery authority server from the plurality of lottery authority servers corresponding to the location of the ATM terminal.

42. The system of claim 41, wherein the game play authority system further comprises a memory device for storing lottery purchase information associated with the lottery purchase request, and wherein the one or more memory device of the game play authority system are further encoded with instructions for performing the process comprising action o):
o) matching the lottery purchase request with lottery purchase information previously stored at the game play authority system.
